(19) United States
(12) Patent Application Publication
(10) Pub. No.: US 2014/0261437 A1
(43) Pub. Date: Sep. 18, 2014

(54) Respirator Mask and Filter Unit Therefore

(71) Applicant: Mine Safety Appliances Company, (US)

(72) Inventors: Martin S. Catanzarite, Pittsburgh, PA (US); Eileen Kiefer, Wexford, PA (US); Andrew R. Pozzuto, Washington, PA (US); Roger P. Wolf, Butler, PA (US); Mark P. Taylor, Pittsburgh, PA (US); Jefferson S. Mendenhall, Volant, PA (US); Craig A. Bero, Cranberry Twp., PA (US)

(73) Assignee: Mine Safety Appliances Company, Cranberry, PA (US)

(21) Appl. No.: 13/796,157

(22) Filed: Mar. 12, 2013

(51) Int. Cl. A62B 23/02; A62B 18/08; A62B 18/02

(52) U.S. Cl. CPC A62B 23/02; A62B 18/02; A62B 18/084
USPC 128/206.17; 128/206.12

(57) ABSTRACT

A filter unit for a respirator mask, including: a body having an air inlet portion, an air outlet portion, and a connector for attaching the filter unit to a portion of the respirator mask; a filter member for filtering the incoming air; and a sealing arrangement having a frame at least partially surrounding a pressure arrangement configured to be urged towards and into contact with a contact portion of the body, such that the passage of air is substantially prevented from passing through at least one of the at least one air inlet portion and the at least one air outlet portion, wherein the pressure arrangement includes a flexible portion to facilitate the urging of the pressure arrangement towards the portion of the body.

### BACKGROUND OF THE INVENTION

1. Field of the Invention

The present invention is generally directed to respirator masks, such as full (face) masks and half (face) masks, and in particular to filter units configured for attachment to such respirator masks

2. Description of the Related Art

As is known in the art, air-purifying respirators are worn on a user's face to protect the individual from noxious gases, vapors, fumes and particulates. In particular, such masks filter the air breathed by a user to remove the noxious gases, vapors, fumes, and particulates while enabling oxygen in the atmosphere to reach the user. An air-purifying respirator typically consists of three parts: a face-piece, a filter unit, and a head harness for attaching the respirator to the user's head. The face-piece can be or include a full-face respirator mask, covering the entire face and forming a seal therewith; or it can be a half-face respirator mask, covering only the nose and mouth and forming a seal there-around. The head harness typically consists of a yoke with straps attached thereto. The yoke is attached to the face-piece, such that when the straps are worn, the head harness keeps the face-piece sealed against the face.

The filter unit is connected to the face-piece, such as at an air inhalation portion, and removes the noxious substances from the air as it is inhaled into the face-piece. The face-piece also often includes an air exhalation portion, which permits expired air to be vented directly to the outside of the face-piece, but which remains closed during inhalation so that all inhaled air passes through the filter unit. Further, and as is known, most respirator masks use detachable filter units, such as filter cartridges. These detachable filter units are connected to the air inhalation portions (e.g., air inlet valves) of the respirator mask through which ambient air is drawn as the user inhales. In this manner, the air is filtered before it is inhaled.

Based upon the importance and primary function of a respirator mask, i.e., to protect the user from noxious gases, vapors, fumes, and particulates, it is mandatory to perform a “seal check” after donning the respirator mask, but before entering any potentially affected environment. As such, the Occupational Safety and Health Administration (OSHA) has promulgated mandatory “User Seal Check Procedures” (29 C.F.R. 1910.134 (Appendix B-1)). In particular, Appendix B-1 states:

The individual who uses a tight-fitting respirator is to perform a user seal check to ensure that an adequate seal is achieved each time the respirator is put on. Either the positive and negative pressure checks listed in this appendix, or the respirator manufacturer's recommended user seal check method shall be used. User seal checks are not substitutes for qualitative or quantitative fit tests.

I. Facepiece Positive and/or Negative Pressure Checks

A. Positive pressure check. Close off the exhalation valve and exhale gently into the facepiece. The face fit is considered satisfactory if a slight positive pressure can be built up inside the facepiece without any evidence of outward leakage of air at the seal. For most respirators this method of leak testing requires the wearer to first remove the exhalation valve cover before closing off the exhalation valve and then carefully replacing it after the test.

B. Negative pressure check Close off the inlet opening of the canister or cartridge(s) by covering with the palm of the hand(s) or by replacing the filter seal(s), inhale gently so that the facepiece collapses slightly, and hold the breath for ten seconds. The design of the inlet opening of some cartridges cannot be effectively covered with the palm of the hand. The test can be performed by covering the inlet opening of the cartridge with a thin latex or nitrile glove. If the facepiece remains in its slightly collapsed condition and no inward leakage of air is detected, the tightness of the respirator is considered satisfactory.

### II. Manufacturer's Recommended User Seal Check Procedures

The respirator manufacturer's recommended procedures for performing a user seal check may be used instead of the positive and/or negative pressure check procedures provided that the employer demonstrates that the manufacturer's procedures are equally effective.

Accordingly, it is recognized that ensuring a proper seal between the user's face and the respirator mask is of the utmost importance. Therefore, there is room in the art for improvements in the performance of such “seal checks,” in both efficiency and accuracy. Still further, and due to the conditions in many of the environments in which such respirator masks are worn, the filter unit, and in particular, the filter member therein, should preferably be protected from impact or undesirable contact, e.g., splashed liquid material, sparks, and the like. Therefore, there is also room in the art for improvements in the protection of the filter unit from adverse environmental impact or contact.

### SUMMARY OF THE INVENTION

Generally, provided are an improved respirator mask and filter units for use in connection with such respirator masks. Preferably, provided are a respirator mask and filter unit therefore that facilitate an efficient and accurate seal check process for the user. Preferably, provided are a respirator mask and filter unit therefore that provide improved filter member protection from impact or undesirable contact.

According to one preferred and non-limiting embodiment, provided is a filter unit including a body having: at least one air inlet portion configured to facilitate the passage of air therethrough; at least one air outlet portion configured to facilitate the passage of air to the respirator mask; and a connector configured to attach the filter unit to a portion of the respirator mask. The filter unit further includes a filter member at least partially positioned in a path between the at least one air inlet portion and the at least one air outlet portion, and a sealing arrangement including a frame at least partially surrounding a pressure arrangement configured to be urged towards and into contact with a contact portion of the body, such that the passage of air is substantially prevented from passing through at least one of the at least one air inlet portion and the at least one air outlet portion, wherein the pressure arrangement comprises a flexible portion configured to facilitate the urging of the pressure arrangement towards the portion of the body.

In another preferred and non-limiting embodiment, provided is a respirator mask, including: a head harness for attaching the respirator mask to a head of a user; at least one air exhalation portion configured to facilitate the passage of exhaled air of the user out of the respirator mask; at least one air inhalation portion configured to facilitate the passage of filtered air into an inner area of the respirator mask; and at least one filter unit. The filter unit includes a body having: at least one air inlet portion configured to facilitate the passage of air therethrough; at least one air outlet portion configured to facilitate the passage of air to the at least one air inhalation portion of the respirator mask; and a connector configured to attach the filter unit to the at least one air inhalation portion of the respirator mask. The filter unit further includes a filter member at least partially positioned in a path between the at least one air inlet portion and the at least one air outlet portion, and a sealing arrangement including a frame at least partially surrounding a pressure arrangement configured to be urged towards and into contact with a contact portion of the body, such that the passage of air is substantially prevented from passing through at least one of the at least one air inlet portion and the at least one air outlet portion, wherein the pressure arrangement comprises a flexible portion configured to facilitate the urging of the pressure arrangement towards the portion of the body.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a front view of one embodiment of a full-face respirator mask and a filter unit according to the principles of the present invention;

FIG. 2 is a side view of the respirator mask and filter unit of FIG. 1;

FIG. 3 is a front view of one embodiment of a half-face respirator mask and a filter unit according to the principles of the present invention;

FIG. 4 is a side view of the respirator mask and filter unit of FIG. 3;

FIG. 5 is a cross sectional view of one embodiment of a filter unit according to the principles of the present invention prior to operation;

FIG. 6 is a cross sectional view of the filter unit of FIG. 5 during operation.

FIG. 7 is a top view of one embodiment of a filter unit according to the principles of the present invention;

FIG. 8 is a bottom view of the filter unit of FIG. 7;

FIG. 9 is a side view of the filter unit of FIG. 7;

FIG. 10 is a first perspective view of the filter unit of FIG. 7;

FIG. 11 is a second perspective view of the filter unit of FIG. 7;

FIG. 12 is a top view of one embodiment of a bottom portion of a filter unit according to the principles of the present invention;

FIG. 13 is a bottom view of the filter unit of FIG. 12;

FIG. 14 is a side view of the filter unit of FIG. 12;

FIG. 15 is a first perspective view of the filter unit of FIG. 12;

FIG. 16 is a second perspective view of the filter unit of FIG. 12;

FIG. 17 is a top view of one embodiment of a top portion of a filter unit according to the principles of the present invention;

FIG. 18 is a bottom view of the filter unit of FIG. 17;

FIG. 19 is a side view of the filter unit of FIG. 17;

FIG. 20 is a first perspective view of the filter unit of FIG. 17;

FIG. 21 is a second perspective view of the filter unit of FIG. 17

FIG. 22 is a top view of one embodiment of a top portion of a filter unit according to the principles of the present invention;

FIG. 23 is a bottom view of the filter unit of FIG. 22;

FIG. 24 is a side view of the filter unit of FIG. 22;

FIG. 25 is a first perspective view of the filter unit of FIG. 22;

FIG. 26 is a second perspective view of the filter unit of FIG. 22.

FIG. 27 is a top view of one embodiment of a top portion of a filter unit according to the principles of the present invention;

FIG. 28 is a bottom view of the filter unit of FIG. 27;

FIG. 29 is a side view of the filter unit of FIG. 27;

FIG. 20 is a first perspective view of the filter unit of FIG. 27; and

FIG. 31 is a second perspective view of the filter unit of FIG. 27.

### DETAILED DESCRIPTION OF THE PREFERRED EMBODIMENTS

For purposes of the description hereinafter, the terms “upper,” “lower,” “right,” “left,” “vertical,” “horizontal,” “top,” “bottom” and derivatives and equivalents thereof shall relate to the invention as it is oriented in the drawing figures. However, it is to be understood that the invention may assume various alternate variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention is directed to a full-face respirator mask 100, a half-face respirator mask 102, and a filter unit 10 for use in connection with the full-face respirator mask 100 and/or the half-face respirator mask 102. One preferred and non-limiting embodiment of the full-face respirator mask 100 according to the present invention is illustrated in FIGS. 1 and 2, and one preferred and non-limiting embodiment of the half-face respirator mask 102 according to the present invention is illustrated in FIGS. 3 and 4. In addition, certain preferred and non-limiting embodiments of the filter unit 10 (and various portions thereof) are illustrated in FIGS. 5-21. While, as discussed hereinafter, the filter unit 10 can be used in connection with and attached to the full-face respirator mask 100 and the half-face respirator mask 102, it can be configured or adapted to attach to or fit with any type of respirator mask, respirator, face mask, face-piece, and the like.

In one preferred and non-limiting embodiment, and as illustrated in FIGS. 1 and 2, the full-face respirator mask 100 includes a head harness 104, typically including a number of adjustable straps 106, for use in attaching the mask 100 to a head of a user. Of course, any suitable head harness 104 can be used to releasably and adjustably secure the respirator mask 100 to the user. In addition, the respirator mask 100 includes at least one air exhalation portion 108 or arrangement configured to facilitate the passage of exhaled air, from the user out of an inner area 110 of the respirator mask 100. In particular, as the user exhales air within the inner area 110 of the mask 100, it moves through this air exhalation portion 108, typically in the form of or including a one-way valve or the like.

With continued reference to FIGS. 1 and 2, the respirator mask 100 includes at least one (and typically two) air inhalation portions 112 or arrangements. These air inhalation portions 112 or arrangements are used to facilitate the passage of filtered air from the filter unit 10 into the inner area 110 of the mask 100. In addition, the full-face respirator mask 100 includes a face-piece 114, upon or through which the air exhalation portion 108 and air inhalation portions 112 are arranged or positioned. In addition, this face-piece 114 includes a face shield 116, which is a transparent member through which the user can view the surrounding environment (as the full-face respirator mask 100 covers the entirety of the user's face). As discussed, and in this preferred and non-limiting embodiment, two filter units 10 according to the present invention are attached to or used in connection with the respirator mask 100; however, it is also envisioned that the full-face mask 100 includes only one air inhalation portion 112, such that only one filter unit 10 is used.

In another preferred and non-limiting embodiment, and as illustrated in FIGS. 3 and 4, the filter unit 10 can also be fitted to or used in connection with a half-face respirator mask 102. This half-face respirator mask 102 includes similar components to those discussed above in connection with the full-face mask 100, including, but not limited to, the head harness 104 (e.g., the straps 106), the air exhalation portion 108, the inner area 110, the air inhalation portions 112, and the face-piece 114. However, the half-face mask 102 only covers a portion of the user's face, and typically does not include the face shield 116 discussed above. Instead, the user normally wears safety glasses or the like depending upon the environment in which he or she is working. Also, as discussed above in connection with the full-face respirator mask 100, the half-face respirator mask 102 may include any number of air exhalation portions 108 and/or air inhalation portions 112, where a filter unit 10 is used in connection with or fitted to the air inhalation portions 112 of the respirator mask 102.

One preferred and non-limiting embodiment of the filter unit 10 will now be discussed in greater detail. In particular, and with respect to FIGS. 5-21, the filter unit 10 includes a body 12 having an air inlet portion 14, which is configured or arranged to facilitate the passage of air therethrough, and an air outlet portion 16, which is configured or arranged to facilitate the passage of air to the respirator mask 100, 102, specifically the inner area 110 of the mask 100, 102. As discussed hereinafter, the air outlet portion 16 of the filter unit 10 is positioned or configured to interact with a respective air inhalation portion 112 of the respirator mask 100, 102, thus providing filtered air to the inner area 110 of the mask 100, 102. In addition, the body 12 includes a connector 18 for removably attaching the filter unit 10 to a portion of the respirator mask 100, 102, such as some structure associated with the air inhalation portion 112 of the respirator mask 100, 102.

According to this preferred and non-limiting embodiment, the filter unit 10 also includes a filter member 20, which is positioned in a path between the air inlet portion 14 and air outlet portion 16. As is known, it is this filter member 20 that filters the contaminants from the incoming air (i.e., from the outside environment) prior to introduction to the air inhalation portions 112 of the respirator mask 100, 102. This filter member 20 may take a variety of forms, sizes, and shapes, according to the size and structure of the filter unit 10. While normally such a filter member 20 is disposable or disposed of with the filter unit 10 after use, it is envisioned that a replaceable filter member 20 could also be used.

As best illustrated in FIGS. 5 and 6, the filter unit 10 further includes a sealing arrangement 22, which includes a frame 24 that at least partially surrounds a pressure arrangement 26. At least a portion of this pressure arrangement 26 is configured or adapted to be urged towards and into contact with a contact portion 28 of the body 12. Through this contact or engagement, the passage of air is substantially prevented from passing through the air inlet portion 14 and/or the air outlet portion 16, and thus, into the inner area 110 of the respirator mask 100, 102. In addition, this pressure arrangement 26 includes a flexible portion 30 that facilitates this urging of the pressure arrangement 26 towards the contact portion 28 of the body 12.

In this manner, the filter unit 10 includes a sealing arrangement 22 that is operable from a first position (as shown in FIG. 5) to a second position (as shown in FIG. 6). Therefore, and in one preferred and non-limiting embodiment, during operation and urging of the pressure arrangement 26 towards the contact portion 28 of the body 12, and after such contact is made, air can no longer pass through the air inlet portion 14 to the air outlet portion 16, and into the inner area 110 of the respirator mask 100, 102. Accordingly, by using the described sealing arrangement 22, an appropriate seal is made, such that the user may then perform a “seal check,” as described above. This unique configuration of the sealing arrangement 22 allows for the quick and simple process for performing the “seal check,” namely, the user depresses a portion of the pressure arrangement 26, such that sealing contact or engagement is made between at least a portion of the pressure arrangement 26 and the contact portion 28. Thereafter, the user inhales, and the respirator mask 100, 102 should be urged closer to the user's face based upon the vacuum created in the inner area 110 of the respirator mask 100, 102. This provides the user with the assurance that an appropriate seal has been formed between the user's mouth and nose and the outside environment.

In a further preferred and non-limiting embodiment, and as best seen in FIGS. 12-16, the air inlet portion 14 of the filter unit 10 includes an opening rim 32 that at least partially surrounds an air inlet opening 34. This air inlet opening 34 is in fluid communication with the filter member 20, such that air from the outside environment enters the filter unit 10 and passes through the air inlet opening 34 to the filter member 20. In this embodiment, it is at least a portion of this opening rim 32 that acts as the contact portion 28, with which the pressure arrangement 26 is configured to movably contact or engage (and which provides a seal within the filter unit 10). Specifically, through the contact between at least a portion of the pressure arrangement 26 and the opening rim 32, air outside of the filter unit 10 is prevented from entering the air inlet opening 34. As discussed above, and when a user inhales or otherwise creates a vacuum within the respirator mask 100, 102, it is this contact or engagement between the pressure arrangement 26 and the opening rim 32 that facilitates such a “seal check.”

In another preferred and non-limiting embodiment, the opening rim 32, as well as the air inlet opening 34, is substantially circular in form. In addition, and in another embodiment, at least one grate member 36 is positioned and extends at least partially across the air inlet opening 34. This grate member 36 is used to retain the filter member 20 in its position in the filter unit 10, while, at the same time, allowing air to pass through the air inlet opening 34 and contact the filter member 20.

As discussed above, and in one preferred and non-limiting embodiment, the filter unit 10 includes at least one contact surface 38 that is sized, shaped, or configured to movably contact the opening rim 32 (i.e., the contact portion 28). Further, and in one preferred and non-limiting embodiment, the contact surface 38 is a surface of the pressure arrangement 26, as illustrated in FIG. 18. In one embodiment, this contact surface 38 is at least partially formed by the flexible portion 30, which provides a better seal between the pressure arrangement 26 and the opening rim 32. As discussed above, and once contact between the pressure arrangement 26 (or contact surface 38) and the contact portion 28 (or opening rim 32) is made, air is prevented from passing through the air inlet opening 34 and to or through the air outlet portion 16, and further to the inner area 110 of the respirator mask 100, 102. A further preferred and non-limiting embodiment illustrating operation or movement of this contact surface 38 is shown in FIGS. 5 and 6, which represent an “open” and “sealed” position of the pressure arrangement 26.

In another preferred and non-limiting embodiment, and as best seen in FIGS. 13, 14, and 18, the body 12 of the filter unit 10 includes a connection rim 40, which is sized, shaped, or configured to interact with at least a portion of the sealing arrangement 22 for attaching the sealing arrangement 22 to the body 12. In particular, and in this embodiment, the frame 24 of the sealing arrangement 22 includes at least one, and preferably multiple, notches 42 that are sized, shaped, or configured to interact with the connection rim 40. In one preferred and non-limiting embodiment, and as illustrated in FIGS. 5, 6, 18, and 21, these notches 42 are positioned on multiple space projections 44 extending from an inner surface 46 of the frame 24, which permits the passage of air under a portion of the frame 24 when the sealing arrangement 22 is attached. In operation, and in order to attach the sealing arrangement 22 to the body 12, the sealing arrangement 22 (or frame 24) is urged down over the connection rim 40 until the connection rim 40 interacts with and engages the notches 42 of the projections 44. It is further envisioned that the sealing arrangement 22 is removably attached to the body 12 (e.g., through the use of the above-discussed connection rim 40 and notches 42), and alternatively, and based upon the sizes, shapes, and configurations of the connection rim 40 and the notches 42, a substantially permanent fit can also be obtained. Of course, any suitable manner and arrangement for permanently or removably attaching the sealing arrangement 22 to the body 12 can be used without departing from the spirit and scope of the present invention.

With reference to the respirator mask of FIGS. 1 and 3, and the filter unit 10 (as best illustrated in FIGS. 8, 11, 13, and 16) the connector 18, in one preferred and non-limiting embodiment, includes an attaching portion 48 that includes at least one air outlet opening 50, through which filtered air (from the filter member 20) passes to the inner area 110 of the respirator mask 100, 102. In particular, at least a portion of the attaching portion 48 is sized, shaped, or configured to interact with a portion of the air inhalation portion 112 of the respirator mask 100, 102. Specifically, and in one preferred and non-limiting embodiment, the attaching portion 48 includes an extension surface 52 having notches 54 for interaction with a respective tab 118 of the respirator mask 100, 102. In operation, the user urges the attaching portion 48 of the filter unit 10, and specifically the notches 54, over the tabs 118 of the air inhalation portion 112 of the respirator mask 100, 102. Thereafter, the user twists the filter unit 10, such that the tabs 118 of the respirator mask 100, 102 extend over and abut portions of the extension surface 52. In order to remove the filter unit 10 from the respirator mask 100, 102, the filter unit 10 is simply twisted to align the notches 54 with the tabs 118, such that the filter unit 10 can be removed.

It is recognized that any suitable arrangement or configuration for removably attaching the filter unit 10 to the respirator mask 100, 102 can be used. In addition, the air inhalation portion 112 of the respirator mask 100, 102 may include a gasket 120, which is urged or pressed against a portion of the extension surface 52 of the attaching portion 48 in order to create a better seal at the juncture between the filter unit 10 and the respirator mask 100, 102. The notches 54 and tabs 118 may be in any suitable arrangement or configuration in order to allow appropriate interaction, and may further include additional notches or tabs to otherwise limit the twisting motion of the filter unit 10 when attaching it to the air inhalation portion 112 of the respirator mask 100, 102. Specifically, and similar to the threading of a cap onto a bottle, the notches 54, tabs 118, attaching portion 48, and/or air inhalation portion 112 may be formed with or include mating structures, threaded structures, bearing structures, and the like in order to allow for the quick and simple attachment and detachment of the filter unit 10 to and from the respirator mask 100, 102.

In another preferred and non-limiting embodiment, and as best seen in FIGS. 8 and 13, the connector 18 may further include a grate member 56 that is positioned in or extends at least partially across the air outlet opening 50 of the body 12. As with the grate member 36, the grate member 56 is sized, shaped, or configured to assist in retaining the filter member 20 within or with respect to the body 12.

With reference to FIGS. 7 and 17, and in another preferred and non-limiting embodiment, the pressure arrangement 26 includes a substantially rigid portion 58, which includes a contact surface 60 that is sized, shaped, or configured to be engaged or contacted by a user in order to urge the pressure arrangement 26 towards the contact portion 28 of the body 12. This rigid portion 58 may be attached to or integrated with the flexible portion 30; however, in another preferred and non-limiting embodiment, at least a portion of the flexible portion 30 is used as or forms the contact surface 60. In one embodiment, the flexible portion 30 is made from different materials, such that a central, preferably circular, area of the flexible portion 30 is manufactured from a stiffer material to allow for appropriate pressure by the user and urging of the pressure arrangement 26 towards the contact portion 28 of the body 12.

In another preferred and non-limiting embodiment, the contact surface 60 is in the form of the above-discussed rigid portion 58, which is attached to the flexible portion 30. In this embodiment, the rigid portion 58 is substantially disc-shaped and centrally located with respect to the frame 24. Such a configuration allows the user to easily locate this contact surface 60. In addition, the shape of the contact surface 60, such as the substantially circular or disc shape discussed above, allows the user to apply uniform pressure when urging the pressure arrangement 26 towards the contact portion 28. This, in turn, ensures that the appropriate seal is made between the pressure arrangement 26 and the contact portion 28 to facilitate an accurate “seal check.” It is envisioned that this contact surface 60 may take a variety of forms, or include other supportive structure or features that allow for this uniform pressure and urging, and engagement, between the pressure arrangement 26 and contact portion 28. In addition, it is envisioned that any portion or area of the pressure arrangement 26, the contact portion 28, and/or the contact surface 38 is sized, shaped, or configured to ensure proper contact and sealing engagement to prevent the passage of air through the air inlet portion 14 and out of the air outlet portion 16 to the respirator mask 100, 102.

In another preferred and non-limiting embodiment, and as best seen in FIGS. 17 and 18, the flexible portion 30 is attached in or extends across an opening of the frame 24, and at least a portion of the flexible portion 30 includes a flexible hinge 62. It is this flexible hinge 62 that allows and facilitates the movement of the pressure arrangement 26 (or at least a portion thereof) between the “open” and “sealed” positions (as shown in FIGS. 5 and 6). In one preferred and non-limiting embodiment, this flexible hinge 62 extends substantially around the periphery of the rigid portion 58, such that the rigid portion 58 is urged (or moveable) towards the contact portion 28, e.g., the connection rim 40 (or contact surface 38), of the body 12, in order to achieve the sealing function. In addition, and in this preferred and non-limiting embodiment, since the flexible portion 30 extends across the opening of the frame 24, and the rigid portion 58 is attached to or positioned on the flexible portion 30, it is the bottom surface 64 of the flexible portion 30 that makes contact with and engages the connection rim 40. Based upon the materials of construction of the flexible portion 30, an enhanced seal occurs between the pressure arrangement 26 and the contact portion 28.

In a still further preferred and non-limiting embodiment, as illustrated in FIGS. 22-26, the sealing arrangement 22 includes a pressure arrangement 26 having a flexible portion 30 that at least partially includes multiple flexible hinges 74 (as opposed to the substantially continuous flexible hinge 62 discussed above). In particular, these hinges 74 are formed or connected between an outer frame portion 66 and a contact portion 68 (which at least partially forms the contact surface 60, as discussed above). In addition, and in this embodiment, these hinges 74 are positioned such that multiple spaces 70 are formed between the flexible hinges 74. As also seen in FIG. 22-26, and in this preferred and non-limiting embodiment, the outer frame portion 66 is substantially circular, and the contact portion 68 is substantially disc-shaped. Further, the spaces 70 may be partially or wholly used to provide or facilitate air input from the environment to the air inlet portion 14 of the body 12.

With continued reference to FIGS. 22-26, the contact portion 68 may also include a center projection 72 that assists the user in quickly and easily locating the central area of the contact portion 68. In operation, and since the “seal check” occurs when the filter unit 10 is attached to the mask 100, 102, the filter unit 10 is facing away from and out of the user's line of sight. Accordingly, this center projection 72 provides an easy manner for locating the central portion of the contact portion 68 for urging the bottom surface 64 towards and against the contact portion 28 of the body 12. Still further, and in this embodiment, some or all of the frame 24, the contact portion 68, and the flexible hinges 74 are manufactured or molded from the same material, such as a material that exhibit enough flexibility and/or resiliency to facilitate the bending and flexing of the hinges 74, but having enough rigidity that the entire contact portion 68 can be urged towards and against the contact portion 28 of the body 12. However, it is envisioned that these different components, or a portion thereof, are manufactured or formed from different materials. It is further envisioned that portions or all of the frame 24, sealing arrangement 22, and/or pressure arrangement 26 are co-extruded or molded in a single processing step.

With continued reference to FIGS. 25 and 26, and in this embodiment, the notches 42 of the projections 44 are shaped differently than the notches 42 discussed above in connection with the frame 24 of FIGS. 5-11 and 17-21. In particular, the notches 42 of the frame 24 of the embodiment illustrated in FIGS. 22-26 are sized and shaped to facilitate the adhesive attachment of at least a portion of the connection rim 40 of the body 12 directly to these notches 42. Any type or manner of permanent or semi-permanent connection or adhesion (e.g., glue or the like) can be used to attach the connection rim 40 to or within the notches 42. In one preferred and non-limiting embodiment, the adhesive is selected such that the attachment is permanent, which ensures that the frame 24 does not accidently become disconnected from the body 12, and further ensures that the filter member 20 is not reused.

In a still further preferred and non-limiting embodiment, and as illustrated in FIGS. 27-31, the general arrangement, including the flexible hinges 62 and the contact portion 68 of the pressure arrangement 26, of the embodiment of FIGS. 22-26 are present. However, in the embodiment of FIGS. 27-31, the flexible portion 30 further includes a substantially continuous flexible hinge 62 extending between and/or at least partially under the hinges 74 discussed above. In particular, the spaces 70 in the embodiment of FIGS. 22-26 are replaced (or filled) with this flexible hinge 62. The flexible hinge 62 is formed for a material having greater flexibility and/or resiliency than the material used to form the hinges 74 (and the contact portion 68). Accordingly, these hinges 74 may provide some additional enhancement to the structural stability of the flexible hinge 62 over multiple uses and in a variety of environments. Further, these hinges 74 may be formed (as well as the frame 24 and the contact portion 68) in a single molding process or step, with the substantially continuous hinge 62 formed thereafter. It is further noted that when the hinge 62 is formed in the spaces 70, the air flows to the air inlet portion 14 of the body 12 in a manner similar to that illustrated in FIGS. 5 and 6, i.e., it does not flow through any spaces 70—which are filled or replaced by the substantially continuous hinge 62.

Still further, and based upon the enhanced flexible and/or resilient nature of the material of construction of the flexible hinge 62, at least a portion of the bottom surface 64 is coextensive with the hinge 62 and in the form of a ridge 76. It is at least a portion of this flexible ridge 76 that is urged towards and in contact with the contact portion 28 of the body 12. This, in turn, provides a greater seal between the sealing arrangement 22 and the body 12 (at the ridge/contact portion interface). In addition, at least a portion of the outer frame portion 66 includes or is coextensive with the hinge 62 and ridge 76. For example, the outer surface 78 of portions of the frame 24, such as surfaces opposing the inner projections 44, can be formed with or covered by this more flexible and/or resilient material, thus forming flexible grip portions 80. These flexible grip portions lead to an enhanced user gripping feature of the filter unit 10.

As discussed above, the various components of the filter unit 10 may be manufactured from a variety of materials in order to beneficially enhance the functioning of the filter unit 10, and particularly the movement and sealing capabilities of the pressure arrangement 26. Accordingly, any portion or component of the pressure arrangement 26, and preferably the flexible portion 30, can be made from a flexible material, a resilient material, a synthetic material, a thermoplastic material, a thermoplastic elastomer material, and the like. In addition, when using the rigid portion 58, such as in the form of the disc-shaped member, this component can be manufactured from a synthetic material, a thermoplastic material, polypropylene, plastic, and the like. Still further, and in the embodiment of FIGS. 22-26, it is noted that the hinges 74 and contact portion 68 can be formed of any suitable material that can provide the appropriate flexing and movement, primarily based upon the geometry and dimensions of the hinges 74. Accordingly, the embodiment of FIGS. 22-26 may include a frame 24, hinges 74, and contact portion 68 all formed from the same material, such as a synthetic material, a thermoplastic material, polypropylene, plastic, and the like.

As described, and in this manner, the present invention provides a respirator mask 100, 102 and filter unit 10 that represents an advance in the art. In particular, and based upon the positioning and operation between the pressure arrangement 26 and the body 12, the filter unit 10 provides a simple and quick way of performing a “seal check” by the user of the respirator mask 100, 102. In addition, and based upon the unique arrangement between the pressure arrangement 26 and the body 12, air is easily able to enter under the frame 24, through the air inlet opening 34, further through the filter member 20, and out of the air outlet opening 50. Accordingly, the filtered air moves through the air inhalation portion 112 and into the inner area 110 for inhalation by the user of the respirator mask 100, 102. However, such an arrangement also prevents environmental impact, such as splashing or sparks, from entering or impacting the filter unit 10, and in particular, the filter member 20. Still further, and based upon the compact and simple movement of the pressure arrangement 26 of the filter unit 10, the user can perform an accurate “seal check” in an easy and quick operation.

The preferred embodiments of the invention have been described in detail herein. However, it will be appreciated by those skilled in the art that various modifications and alternatives to the preferred embodiments may be made to the invention without departing from the concepts disclosed in the foregoing description. Such modifications are to be considered as included within the following claims unless the claims, by their language, expressly state otherwise. Accordingly, the particular embodiments described in detail hereinabove are illustrative only and are not limiting as to the scope of the invention, which is to be given the full breadth of the appended claims and any and all equivalents thereof

What is claimed is:

1. A filter unit for a respirator mask, comprising:
(a) a body, comprising: at least one air inlet portion configured to facilitate the passage of air therethrough; at least one air outlet portion configured to facilitate the passage of air to the respirator mask; and a connector configured to attach the filter unit to a portion of the respirator mask;
(b) a filter member at least partially positioned in a path between the at least one air inlet portion and the at least one air outlet portion; and
(c) a sealing arrangement, comprising a frame at least partially surrounding a pressure arrangement configured to be urged towards and into contact with a contact portion of the body, such that the passage of air is substantially prevented from passing through at least one of the at least one air inlet portion and the at least one air outlet portion, wherein the pressure arrangement comprises a flexible portion configured to facilitate the urging of the pressure arrangement towards the contact portion of the body.

2. The filter unit of claim 1, wherein the at least one air inlet portion comprises at least one opening rim at least partially surrounding at least one air inlet opening, which is in fluid communication with the filter member, wherein the opening rim at least partially comprises the contact portion of the body.

3. The filter unit of claim 2, wherein the at least one opening rim and the at least one air inlet opening are substantially circular.

4. The filter unit of claim 2, further comprising at least one grate member extending at least partially across the at least one air inlet opening and configured to at least partially retain the filter member.

5. The filter unit of claim 2, wherein at least one surface of the pressure arrangement is configured to contact the opening rim to thereby prevent passage of air through the at least one air inlet opening, such that air cannot pass through the air outlet portion and into the respirator mask.

6. The filter unit of claim 1, wherein the body comprises at least one connection rim configured to interact with at least a portion of the sealing arrangement to attach the sealing arrangement to the body.

7. The filter unit of claim 6, wherein the frame of the sealing arrangement comprises at least one notch configured to interact with at least a portion of the connection rim.

8. The filter unit of claim 1, wherein the sealing arrangement is removably attachable to the body.

9. The filter unit of claim 1, wherein the connector of the body comprises an attaching portion having at least one air outlet opening extending therethrough, wherein at least a portion of the attaching portion is configured to interact with at least a portion of an air inhalation portion of the respirator mask to attach the filter unit thereto.

10. The filter unit of claim 9, wherein the attaching portion comprises an extension surface with at least one notch configured to interact with at least one tab of the air inlet portion of the respirator mask.

11. The filter unit of claim 9, wherein the connector further comprises at least one grate member extending at least partially across the at least one air outlet opening and configured to at least partially retain the filter member.

12. The filter unit of claim 1, wherein the pressure arrangement comprises a substantially rigid portion having a contact surface configured to be contacted by a user to urge the pressure arrangement towards the contact portion of the body.

13. The filter unit of claim 12, wherein the flexible portion comprises at least a portion of the contact surface.

14. The filter unit of claim 1, wherein the flexible portion comprises at least one flexible hinge to facilitate urging of the pressure arrangement toward the contact portion of the body.

15. The filter unit of claim 1, wherein at least a portion of the frame and at least a portion of the pressure arrangement are formed from a first material, and at least a portion of the flexible portion is formed from a second, different material.

16. The filter unit of claim 15, wherein the first material is a substantially rigid material and the second, different material is a substantially flexible material.

17. The filter unit of claim 1, wherein at least a portion of the flexible portion comprises at least one of the following: a flexible material, a resilient material, a synthetic material, a thermoplastic material, a thermoplastic elastomer material, or any combination thereof.

18. A respirator mask, comprising:
a head harness for attaching the respirator mask to a head of a user;
at least one air exhalation portion configured to facilitate the passage of exhaled air of the user out of the respirator mask;
at least one air inhalation portion configured to facilitate the passage of filtered air into an inner area of the respirator mask; and
at least one filter unit, comprising: (a) a body, comprising: at least one air inlet portion configured to facilitate the passage of air therethrough; at least one air outlet portion configured to facilitate the passage of air to the at least one air inhalation portion of the respirator mask; and a connector configured to attach the filter unit to the at least one air inhalation portion of the respirator mask; (b) a filter member at least partially positioned in a path between the at least one air inlet portion and the at least one air outlet portion; and (c) a sealing arrangement, comprising: a frame at least partially surrounding a pressure arrangement configured to be urged towards and into contact with a contact portion of the body, such that the passage of air is substantially prevented from passing through at least one of the at least one air inlet portion and the at least one air outlet portion, wherein the pressure arrangement comprises a flexible portion configured to facilitate the urging of the pressure arrangement towards the portion of the body.

19. The respirator mask of claim 18, further comprising two air inhalation portions and two filter units, each configured for attachment to a respective air inhalation portion.

20. In a respirator mask having: a head harness for attaching the respirator mask to a user; at least one air exhalation portion configured to facilitate the passage of exhaled air of the user out of the respirator mask; and at least one air inhalation portion configured to facilitate the passage of filtered air into an inner area of the respirator mask, at least one filter unit, comprising: (a) a body, comprising: at least one air inlet portion configured to facilitate the passage of air therethrough; at least one air outlet portion configured to facilitate the passage of air to the at least one air inhalation portion of the respirator mask; and a connector configured to attach the filter unit to the at least one air inhalation portion of the respirator mask; (b) a filter member at least partially positioned in a path between the at least one air inlet portion and the at least one air outlet portion; and (c) a sealing arrangement, comprising: a frame at least partially surrounding a pressure arrangement configured to be urged towards and into contact with a contact portion of the body, such that the passage of air is substantially prevented from passing through at least one of the at least one air inlet portion and the at least one air outlet portion, wherein the pressure arrangement comprises a flexible portion configured to facilitate the urging of the pressure arrangement towards the portion of the body.
